(19) United States
(12) Patent Application Publication
(10) Pub. No.: US 2014/0174224 A1
(43) Pub. Date: Jun. 26, 2014

(54) TRANSMISSION MECHANISM

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: CHENG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (TW)

(21) Appl. No.: 14/106,815

(22) Filed: Dec. 15, 2013

(30) Foreign Application Priority Data
Dec. 24, 2012 (CN) 2012105638378

(51) Int. Cl. F16H 25/20

(52) U.S. Cl. CPC F16H 25/20
USPC 74/89.32

(57) ABSTRACT

A transmission mechanism includes a screw mandrel and a transmission assembly. The transmission assembly includes a first transmission member, a fixing member, a second transmission member, a first magnetic member, and a second magnetic member. The first transmission member is screwed with the screw mandrel. The fixing member is fixedly-connected to the first transmission member. The second transmission member is screwed with the screw mandrel and resisting against the fixing member to avoid rotating relative to the first transmission member. The first magnetic member is fixedly mounted on the fixing member. The second magnetic member is fixedly mounted on the first transmission member towards the first magnetic member to interact with the first magnetic member.

### BACKGROUND

1. Technical Field

The present disclosure generally relates to transmission mechanisms, and particularly to a screw mandrel type transmission mechanism.

2. Description of the Related Art

Workpieces should be transported accurately by transmission mechanisms to preset positions in productions. A transmission mechanism includes a screw mandrel and a transmission assembly movably assembled to the screw mandrel. A difference exists between a preset transmission distance and an actual distance, because of assembly derivation and friction between the screw mandrel and the transmission assembly. Therefore, the workpiece is not be transmitted to an accurate position.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an assembled, isometric view of an embodiment of a transmission mechanism.

FIG. 2 shows an exploded view of the transmission mechanism of FIG. 1.

FIG. 3 is a cross-sectional view of the transmission mechanism of FIG. 1 taken along line III-III.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

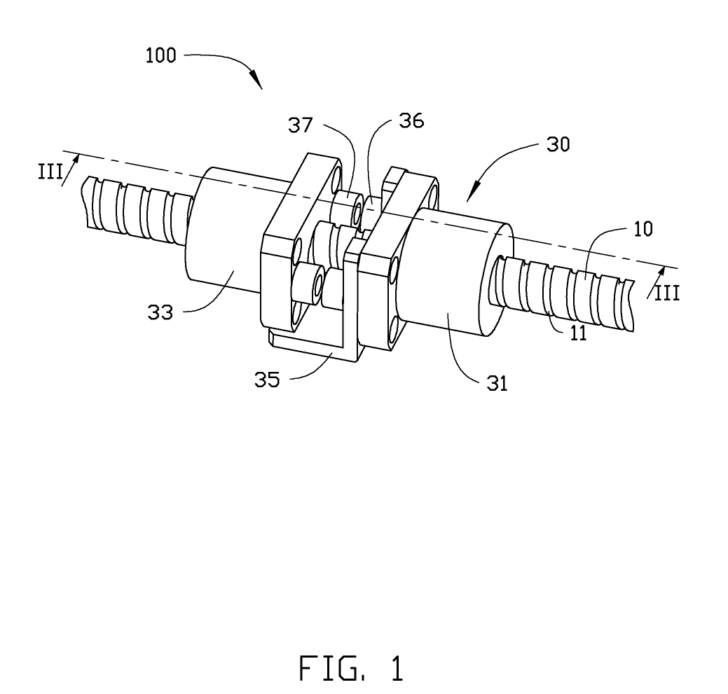

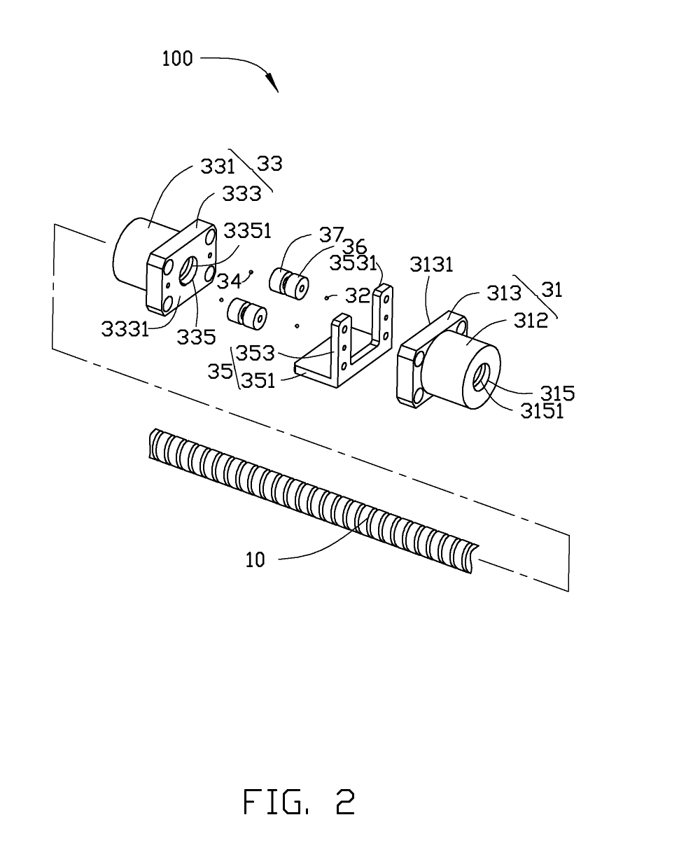

FIGS. 1 and 2 show a transmission mechanism 100. The transmission mechanism 100 includes a screw mandrel 10 and a transmission assembly 30 movably assembled to the screw mandrel 10. Outer threads 11 are formed in a periphery wall of the screw mandrel 10. The transmission assembly 30 includes a first transmission member 31, a plurality of first rolling balls 32, a second transmission member 33, and a plurality of second rolling balls 34, a fixing member 35, a first magnetic member 36, and a second magnetic member 37.

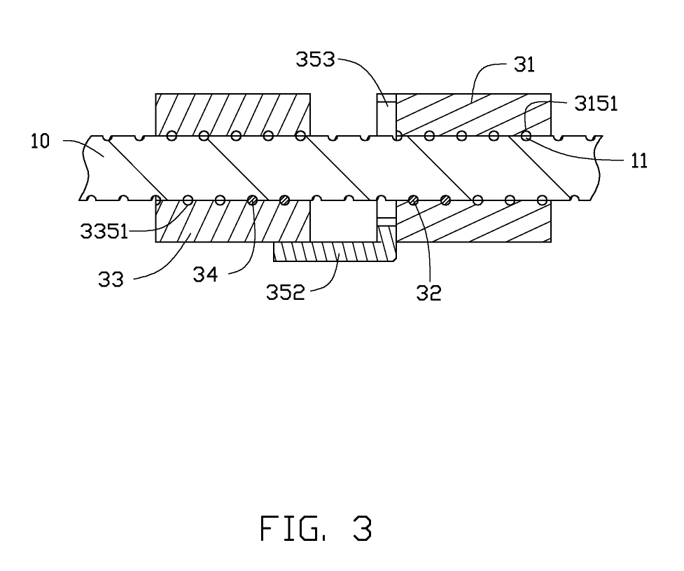

FIG. 3 shows that the first transmission member 31 includes a first body 312 and a first connecting portion 313 protruding from a periphery wall of the first body 312. A first penetrating hole 315 is defined through the first body 312 and the first connecting portion 313. First inner threads 3151 are formed in an inner wall of the first penetrating hole 315 to threadedly engage with the screw mandrel 10. The screw mandrel 10 movably passes through the first penetrating hole 315 for assembling the first transmission member 31 to the screw mandrel 10. A fixing surface 3131 is formed in one side of the first connecting portion 313 away from the first body 312.

As shown in FIG. 3, the first rolling balls 32 are movably received between the first inner threads 3151 and the outer threads 11, for movably assembling the first rolling balls 32 between the first transmission member 31 and the screw mandrel 10.

The second transmission member 33 includes a second body 331 and a second connecting portion 333 protruding from a periphery wall of the second body 331. A second penetrating hole 335 is defined through the second body 331 and the second connecting portion 333. Second inner threads 3351 are formed in an inner wall of the second penetrating hole 335 to threadedly engage with the screw mandrel 10. The screw mandrel 10 movably passes through the second penetrating hole 335 for assembling the second transmission member 33 to the screw mandrel 10. A joining surface 3331 is formed in one side of the second connecting portion 333 away from the second body 331 and positioned towards the fixing surface 3131.

FIG. 3 shows that the second rolling balls 34 are movably received between the second inner threads 3351 and the outer threads 11, for movably assembling the second rolling balls 34 between the second transmission member 33 and the screw mandrel 10.

The fixing member 35 is substantially L-shaped, including a first fixing portion 351 and two second fixing portions 353. The two second fixing portions 353 protrude separately and substantially perpendicularly from one end portion of the first fixing portion 351 away from the second transmission member 33. The second connecting portion 333 is positioned above and resists against the first fixing portion 351. The two second fixing portions 353 are fixedly-connected to the fixing surface 3131. An adhesive surface 3531 is formed in one side of each second fixing portion 353 deviating from the first transmission member 31 and positioned towards the joining surface 3331.

The first magnetic member 36 is mounted on the adhesive surface 3531 towards the second transmission member, and the second magnetic member 37 is mounted on the joining surface 3331, such that the first magnetic member 36 and the second magnetic member 37 are oppositely positioned. A magnetic pole of the first magnetic member 36 facing the second magnetic member 37, has a same polarity as a magnetic pole of the second magnetic member 37 towards the first magnetic member 36 to produce magnet repulsive interactions. In the illustrated embodiment, the first magnetic member 36 and the second magnetic member 37 are magnets. In other embodiments, the magnetic pole of the first magnetic member 36 facing the second magnetic member 37, has a different polarity from the magnetic pole of the second magnetic member 37 towards the first magnetic member 36 to produce attraction.

In assembly, the first rolling balls 32 are partially received in the first inner threads 3151, and the second rolling balls 34 are partially received in the second inner threads 3351. The screw mandrel 10 is received through the first penetrating hole 315 and the second penetrating hole 335, such that the first rolling balls 32 are movably received in the first inner threads 3151 and the outer threads 11, and the second rolling balls 34 are movably received in the second inner threads 3351 and the outer threads 11. The first fixing portion 351 resists against the second connecting portion 333. The two second fixing portions 353 resist against the first connecting portion 313 and fixedly connect to the fixing surface 3131. The first magnetic member 36 is mounted on the adhesive surface 3531, and the second magnetic member 37 is mounted on the joining surface 3331.

When the first transmission member 31 and the second transmission member 33 rotate relative to the screw mandrel 10, magnetic repulsive interactions are produced between the first magnetic member 36 and the second magnetic member 37, the first rolling balls 32 are snugly clamped between sidewalls of the first inner threads 3151 of the first transmission member 31 and sidewalls of the outer threads 11 of the screw mandrel 10, and the second rolling balls 34 are snugly clamped between the second transmission member 33 and sidewalls of the outer threads 11 of the screw mandrel 10.

As described above, the first transmission member 31 and the second transmission member 33 fixedly connected to the first transmission member 31 via the fixing member 35, are assembled with the screw mandrel 10, such that the first transmission member 31 and the second transmission member 33 rotate together at the same time. The first magnetic member 36 is mounted on the adhesive surface 3531, and the second magnetic member 37 is mounted on the joining surface 3331. Magnetic repulsive interactions or magnetic attractions between the first magnetic member 36 and the second magnetic member 37 cause the first rolling balls 32 to be clamped snugly between the first transmission member 31 and the screw mandrel 10, and the second rolling balls 34 clamped snugly between the second transmission member 33 and the screw mandrel 10.

In other embodiments, the first and second rolling balls 32, 34 can be omitted, and the screw mandrel 10 are rotated with the first transmission member 31 and the second transmission member 33. Sidewalls of the first inner threads 3151 of the first transmission member 31 and the sidewalls of the outer threads 11 of the screw mandrel 10 snugly engage together, and the sidewall of the second inner threads 3351 of the sidewalls of the outer threads 11 of the screw mandrel 10 snugly engage together, because of the magnet repulsive interactions or magnetic attractions between the first magnetic member 36 and the second magnetic member 37.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A transmission mechanism comprising:
a screw mandrel; and
a transmission assembly comprising:
a first transmission member screwed with the screw mandrel;
a fixing member fixedly-connected to the first transmission member;
a second transmission member screwed with the screw mandrel and resisting against the fixing member to avoid rotating relative to the first transmission member;
a first magnetic member fixedly mounted on the fixing member; and
a second magnetic member fixedly mounted on the first transmission member towards the first magnetic member to interact with the first magnetic member.

2. The transmission mechanism of claim 1, wherein the transmission assembly further comprises a plurality of first rolling balls and a plurality of second rolling balls, the plurality of first rolling balls are clamped between the first transmission member and the screw mandrel, and the plurality of second rolling balls are clamped between the second transmission member and the screw mandrel.

3. The transmission mechanism of claim 2, wherein a first penetrating hole is defined through the first transmission member, a second penetrating hole is defined through the second transmission member, the screw mandrel movably passes through the first penetrating hole and the second penetrating hole, the first rolling balls are movably received in the first penetrating hole to resist against the screw mandrel, and the second rolling balls are movably received in the second penetrating hole to resist against the screw mandrel.

4. The transmission mechanism of claim 3, wherein the screw mandrel comprises outer threads formed in a periphery wall of the screw mandrel, first inner threads are formed in an inner wall of the first penetrating hole, the first rolling balls are movably received in the first inner threads and the outer threads, second inner threads are formed in an inner wall of the second penetrating hole, and the second rolling balls are movably received in the second inner threads and the outer threads.

5. The transmission mechanism of claim 3, wherein the first transmission member comprises a first body and a first connecting portion protruding from a periphery wall of the first body, the first penetrating hole is defined through the first body and the first connecting portion, and the fixing member is fixedly-connected to the fixing member.

6. The transmission mechanism of claim 5, wherein the first connecting portion comprises a fixing surface, and the fixing member is fixedly-connected to the fixing surface.

7. The transmission mechanism of claim 1, wherein the fixing member comprises a first fixing portion and two second fixing portions, the second transmission member is positioned above and resists against the first fixing portion, and the two second fixing portions separately protrude from one end of the first fixing portion away from the second transmission member and fixedly connect to the first transmission member.

8. The transmission mechanism of claim 7, wherein each of the two second fixing portions comprises an adhesive surface formed on one side of each second fixing portion deviating from the first transmission member, and the first magnetic member is mounted on the adhesive surface.
